(19) United States
(12) Patent Application Publication
(10) Pub. No.: US 2021/0341079 A1
(43) Pub. Date: Nov. 4, 2021

(54) Fluid End Valve Having Dual Inserts

(71) Applicant: Kerr Machine Co., Sulphur, OK (US)

(72) Inventors: Micheal Cole Thomas, Ardmore, OK (US); Christopher Todd Barnett, Stratford, OK (US); Kelcy Jake Foster, Ardmore, OK (US); John Keith, Ardmore, OK (US); Nicholas Son, Davis, OK (US)

(21) Appl. No.: 17/245,078

(22) Filed: Apr. 30, 2021

Related U.S. Application Data
(60) Provisional application No. 63/018,021, filed on Apr. 30, 2020.

(51) Int. Cl. F16K 47/08

(52) U.S. Cl. CPC F16K 47/08

(57) ABSTRACT

A valve configured to seal against a valve seat. The valve and valve seat configured to be installed within a fluid end. A recess is formed on the valve's sealing surface. A first and second insert are installed within the recess. The first insert is made of a harder material than the second insert. During operation, the first insert deflects high velocity fluid away from the second insert.

### RELATED APPLICATION

This application claims the benefit of provisional patent application Ser. No. 63/018,021, authored by Thomas et al. and filed on Apr. 30, 2020, the entire contents of which are incorporated herein by reference.

### SUMMARY

The present invention is directed to an apparatus comprising a valve configured to mate with a valve seat. The valve comprises a tapered sealing surface, and a recess formed within at least a portion of the sealing surface. The valve further comprising a first insert installed within the recess, and a second insert installed within the recess and engaging the first insert.

The present invention is also directed to an apparatus comprising a valve configured to mate with a valve seat. The valve comprises a tapered sealing surface, a first insert installed within the sealing surface, and a second insert installed within the sealing surface. The first insert is made of a material that is harder than that from which the second insert is made.

### BRIEF DESCRIPTION OF THE DRAWINGS

FIG. 1 is a perspective view of a fluid end attached to a power end.

FIG. 2 is a cross-sectional view of the fluid end shown in FIG. 1, taken along line A-A.

FIG. 3 is an enlarged view of area B shown in FIG. 2, showing a prior art version of a valve spaced from a valve seat.

FIG. 4 is an enlarged view of area C shown in FIG. 2, showing a prior art version of a valve engaged with a valve seat.

FIG. 5 is a top plan view of a valve of the present invention.

FIG. 6 is a top perspective view of the valve shown in FIG. 5.

FIG. 7 is a side elevational view of the valve shown in FIG. 5.

FIG. 8 is a cross-sectional view of the valve shown in FIG. 7, taken along line D-D.

FIG. 9 is a bottom plan view of the valve shown in FIG. 5.

FIG. 10 is a bottom perspective view of the valve shown in FIG. 5.

FIG. 11 is a bottom perspective exploded view of the valve shown in FIG. 5.

FIG. 12 is the cross-sectional view of the fluid end shown in FIG. 2, with the valve shown in FIG. 5 installed.

FIG. 13 is an enlarged view of area E shown in FIG. 12, showing the valve spaced from the valve seat.

FIG. 14 is an enlarged view of area F shown in FIG. 12, showing the valve engaged with the valve seat.

### DETAILED DESCRIPTION

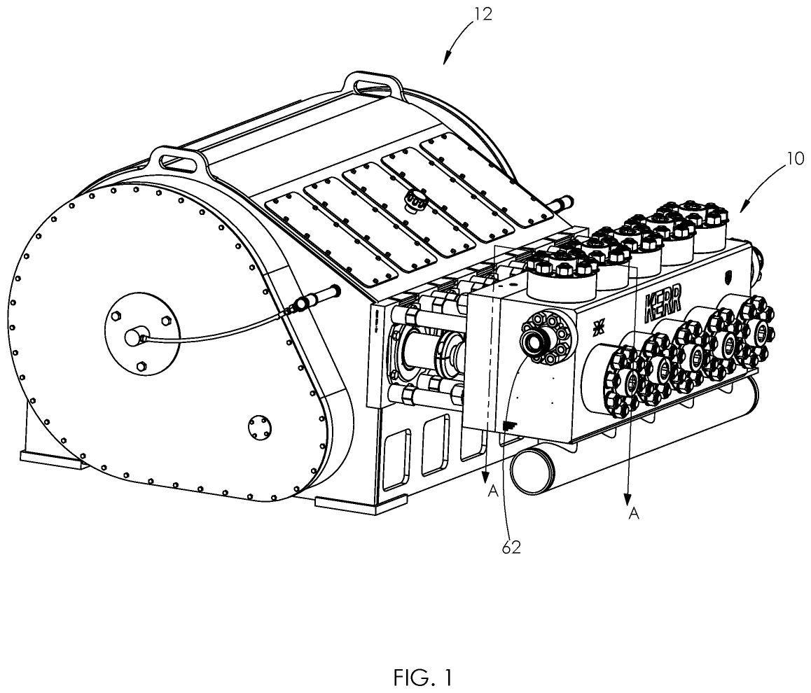

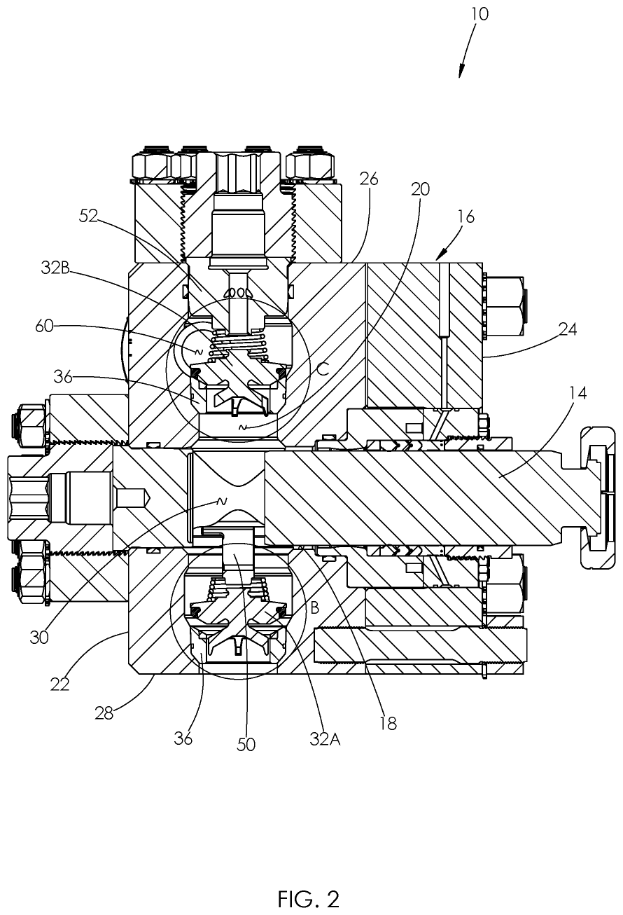

With reference to FIG. 1, a fluid end to is shown attached to a power end 12. Fluid ends, like the fluid end 10, are used in oil and gas operations to deliver highly pressurized corrosive and/or abrasive fluids to piping leading to a wellbore. Power ends, like the power end 12, are configured to reciprocate plungers, like the plunger 14, shown in FIG. 2, within the fluid end to pump fluid throughout the fluid end. Fluid used in high pressure hydraulic fracturing operations is typically pumped through the fluid end at a minimum of 8,000 psi; however, fluid will normally be pumped through the fluid end at pressures around 10,000-15,000 psi during such operations, with spikes up to 22,500 psi.

With reference to FIG. 2, the fluid end 10 comprises a housing 16 having a horizontal bore 18 and a vertical bore 20 extending therethrough. The horizontal bore 18 opens on opposed front and rear surfaces 22 and 24 of the housing 16, and the vertical bore 20 opens on opposed upper and lower surfaces 26 and 28 of the housing 16. The bores 18 and 20 intersect to form an internal chamber 30. The plunger 14 is installed within the horizontal bore 18 through the opening on the rear surface 24. As the plunger 14 reciprocates, it pressurizes fluid contained within the internal chamber 30. A plurality of horizontal and vertical bore pairs 18 and 20 may be formed within a single fluid end housing 16.

Continuing with FIG. 2, fluid is routed throughout the housing 16 using a pair of valves 32—an intake valve 32A and a discharge valve 32B. The valves 32 are identical and are configured to seal against a valve seat 36. The valves 32 and corresponding valve seats 36 are both installed within the vertical bore 20. The intake valve 32A and corresponding valve seat 36 are positioned below the internal chamber 30, and the discharge valve 32B and corresponding valve seat 36 are positioned above the internal chamber 30.

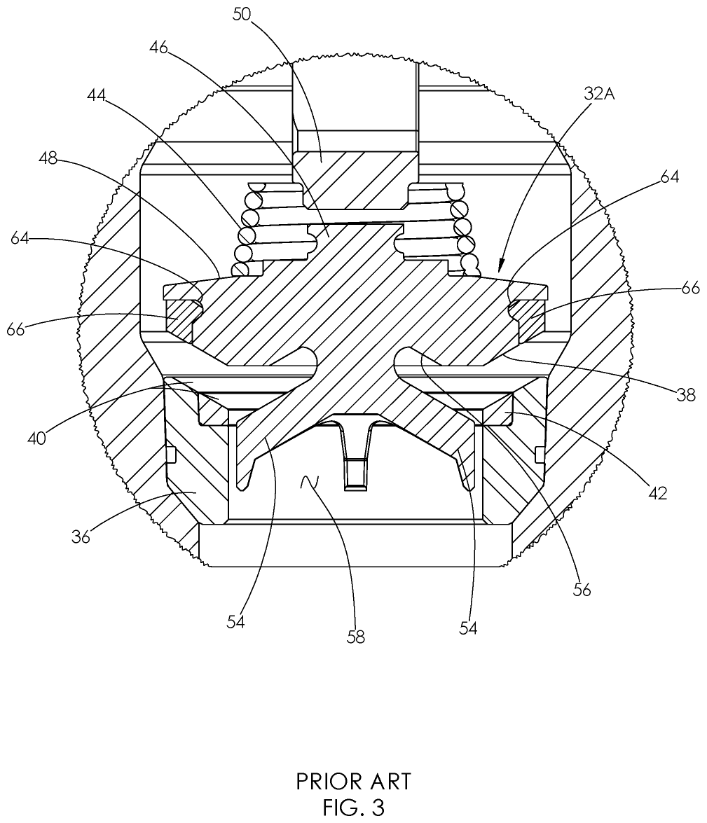

With reference to FIGS. 3 and 4, each valve 32 has a tapered sealing surface 38 that corresponds with a tapered strike face 40 formed on the valve seat 36. The valves 32 are configured to move between open and closed positions. In the open position, the sealing surface 38 is spaced from the strike face 40, as shown in FIG. 3. In the closed position, the sealing surface 38 is engaged with the strike face 40, as shown in FIG. 4. The strike face 40 may be hardened or include a hardened insert 42 to provide durability from the repeated strikes from each valve 32.

A spring 44 biases each valve 32 in the closed position. Fluid pressure moves the valve 32 into the open position. A protrusion 46 is formed on an upper surface 48 of the valve 32 and is configured to engage a valve retainer 50 or a discharge plug 52. Such engagement prevents further axial movement of the valve 32 within the vertical bore 20. A plurality of legs 54 extend from a lower surface 56 of the valve 32. The legs 54 are configured to be received within an opening 58 of the valve seat 36 and ensure that the valve 32 remains properly aligned relative to the valve seat 36.

Turning back to FIG. 2, during operation, fluid enters the housing 16 through the opening of the vertical bore 20 on the lower surface 28 of the housing 16. As fluid enters the housing 16, the fluid pressure below the intake valve 32A is greater than the fluid pressure within the internal chamber 30. As a result, fluid entering the housing 16 forces the intake valve 32A into an open position, allowing fluid to travel around the intake valve 32A and into the internal chamber 30. The reciprocating plunger 14 pressurizes the fluid within the internal chamber 30 and forces the fluid towards the discharge valve 32B. The pressurized fluid traveling towards the discharge valve 32B forces the discharge valve 32B to move into an open position, allowing fluid to travel around the discharge valve 32B and into a discharge bore 60. Pressurized fluid exits the housing 16 through one or more discharge conduits 62, shown in FIG. 1, that are in communication with the discharge bore 60.

During operation, as the plunger 14 retracts, the discharge valve 32B closes and the intake valve 32A opens, pulling fluid into the internal chamber 30. As the plunger 14 extends into the internal chamber 30, the intake valve 32A is closed and the discharge valve 32B opens, expelling fluid towards the discharge bore 60. The valves 32 repeatedly move between an open and closed position as the plunger 14 reciprocates within the housing 16. Because the sealing surface 38 repeatedly strikes the strike face 40, the valve 32 may fail over time due to erosion of the sealing surface 38. If the sealing surface 38 begins to erode, the valve 32 may no longer seal properly against the valve seat 36, allowing fluid to leak around the valve 32. Fluid leakage reduces the fluid pressure and flow capabilities of the fluid end 10.

Turning back to FIGS. 3 and 4, one method of trying to prevent erosion in the sealing surface 38 is to harden the surface 38. The sealing surface 38 may be made from a harder material, such as tungsten carbide, or may be hardened by a post manufacturing process, such as nitriding or flame hardening. However, over time, repeated contact of the hardened sealing surface 38 and strike face 40 may still cause the sealing surface 38 to erode.

Continuing with FIGS. 3 and 4, another method for combating erosion includes forming a recess 64 within the sealing surface 38 for receiving a valve insert 66, in addition to hardening the sealing surface 38. The valve insert 66 is made of any number of durable elastomeric materials known in the art. The elastomeric material may be, for example, made of polyethylene, nitryl rubber, nitrile rubber, or other similar material. The valve insert 66 functions to provide more sealing capabilities for the valve 32.

While the primary sealing is accomplished by the metal-to-metal contact between the sealing surface 38 and the strike face 40, the valve insert 66 encapsulates and seals around any solids trapped between the valve insert 66 and the strike face 40. Upon contact of the valve insert 66 with the strike face 40, the valve insert 66 deforms or compresses so as to take up any empty spaces not fully sealed. In this way, the valve insert 66 serves as a backup or secondary seal to the sealing surface 38. During operation, the valve insert 66 contacts the strike face 40 prior to the metal sealing surface 38. As a result, the valve insert 66 provides incidental reduction of impact force between the sealing surface 38 and the strike face 40, helping to further reduce erosion.

Over time, however, the valve insert 66 may itself erode or retain its deformed or compressed state, potentially causing leakage. Further, as the valve insert 66 begins to erode or retain a deformed or compressed state, the full impact force of the valve 32 striking the valve seat 36 is applied to the sealing surface 38 and the strike face 40. Such impact may lead to further erosion and potentially more leakage around the valve 32.

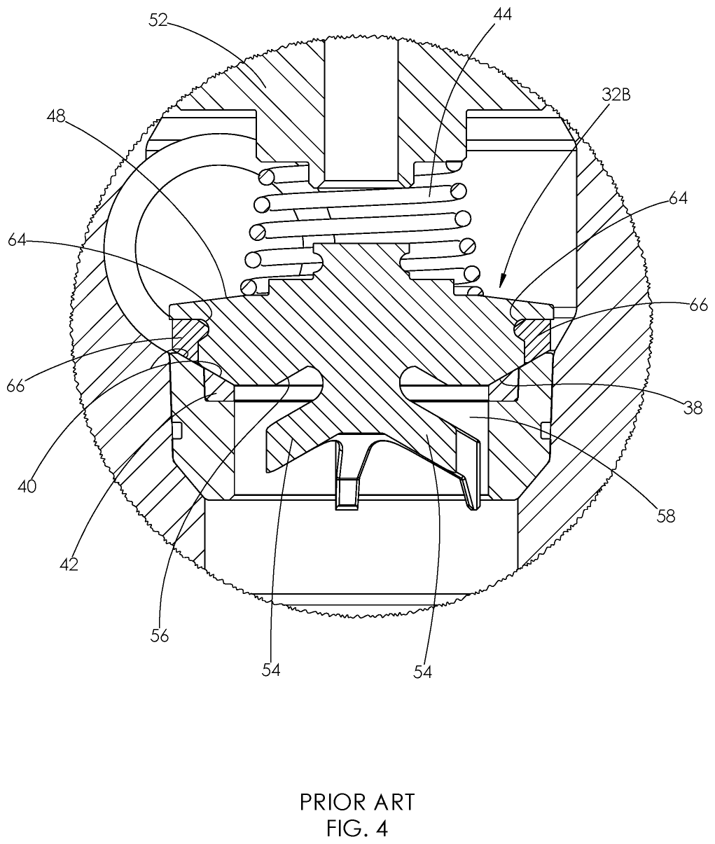

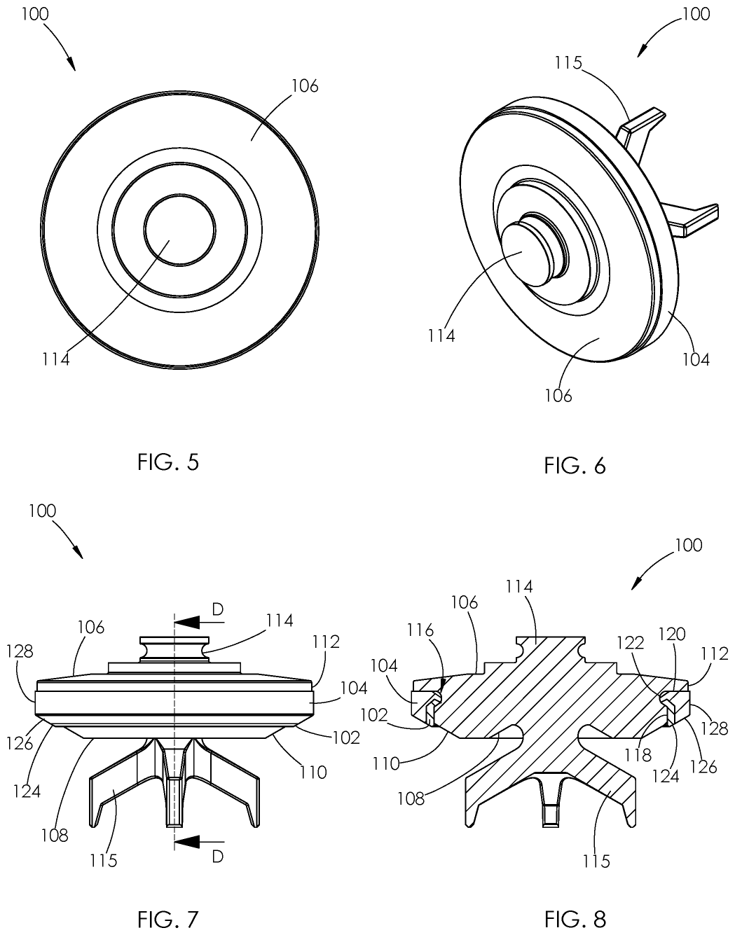

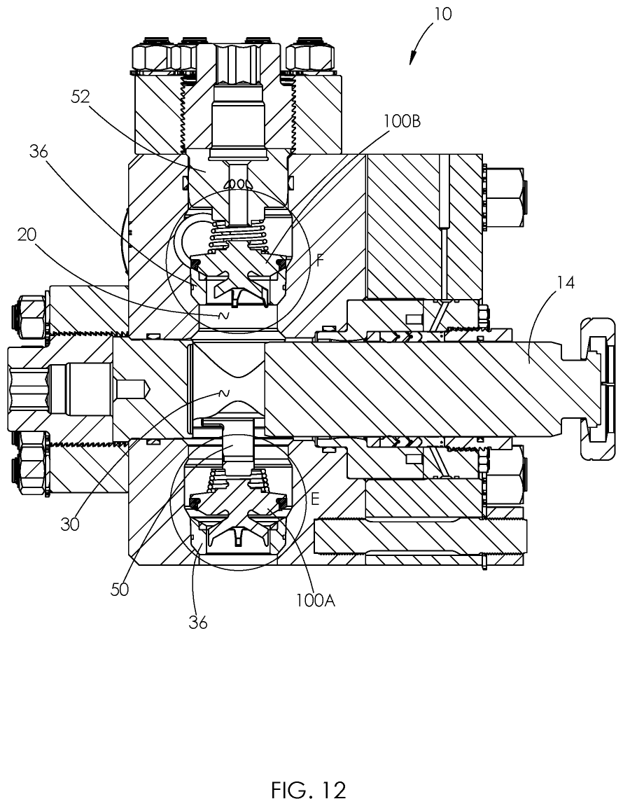

Turning to FIGS. 5-14, a valve 100 of the present invention is shown. As will be described in more detail herein, the valve 100 is identical to the valve 32, but includes a first and a second valve insert 102 and 104. The valve 100 may be used in place of the intake and discharge valves 32A and 32B within the fluid end 10, as shown in FIG. 12. An intake valve 100A is installed below the internal chamber 30, and a discharge valve 100B is installed above the internal chamber 30 within the vertical bore 20.

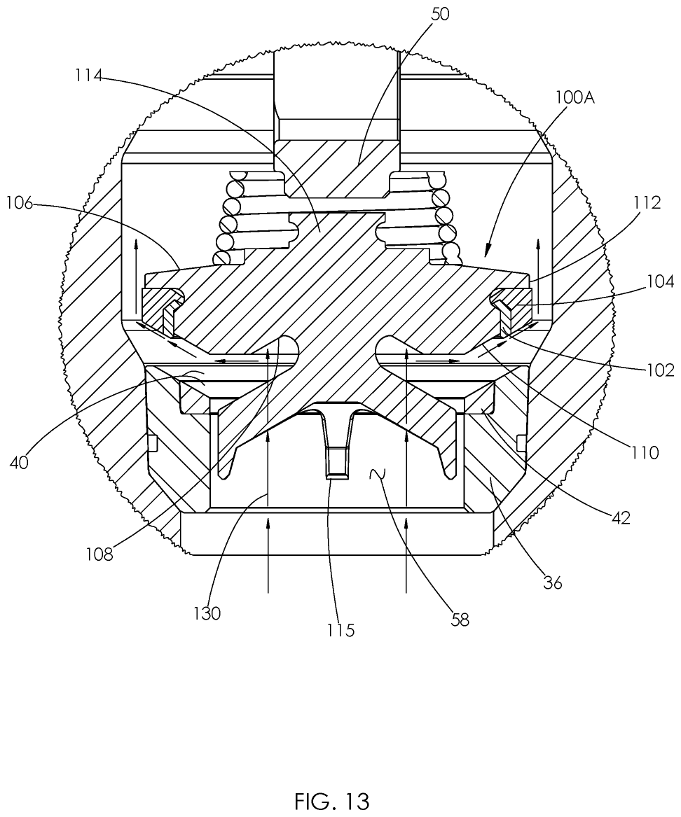

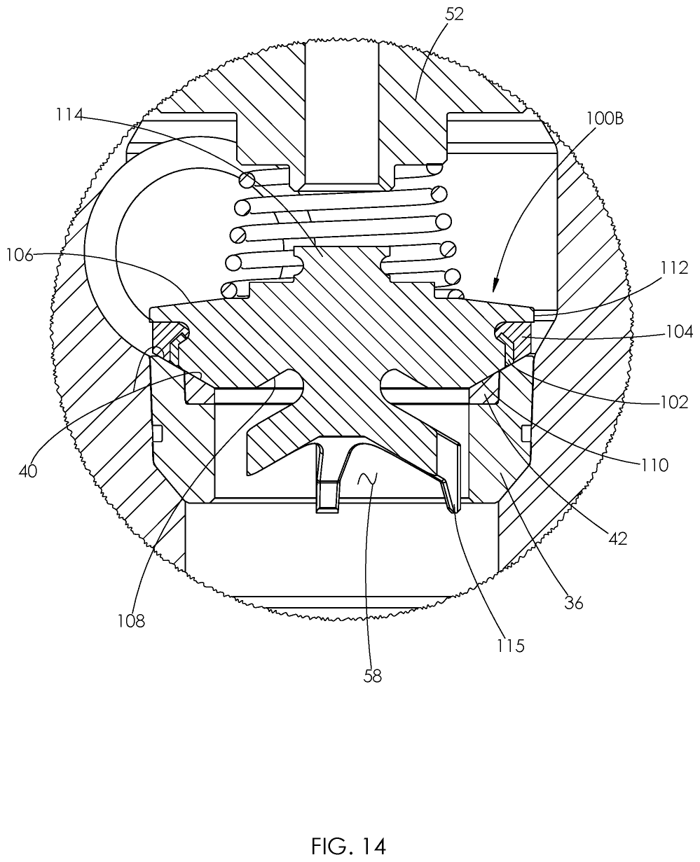

Continuing with FIGS. 5-11, the valve 100 comprises opposed upper and lower surfaces 106 and 108 joined by a sealing surface no and an outer rim 112. A protrusion 114 is formed on the upper surface 106 for engaging the valve retainer 50 or discharge plug 52, as shown in FIG. 12. A plurality of legs 115 extend from the lower surface 108 and are configured to be received within the opening 58 of the valve seat 36, as shown in FIGS. 13 and 14. The metal sealing surface no may be hardened, as described above.

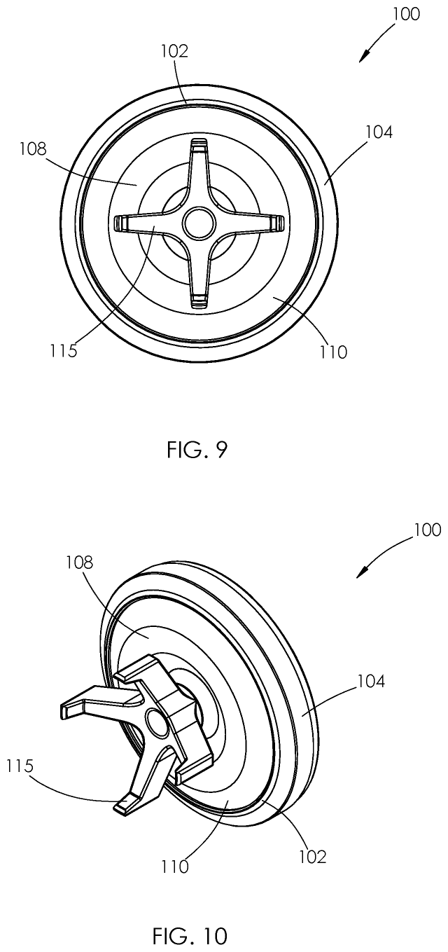

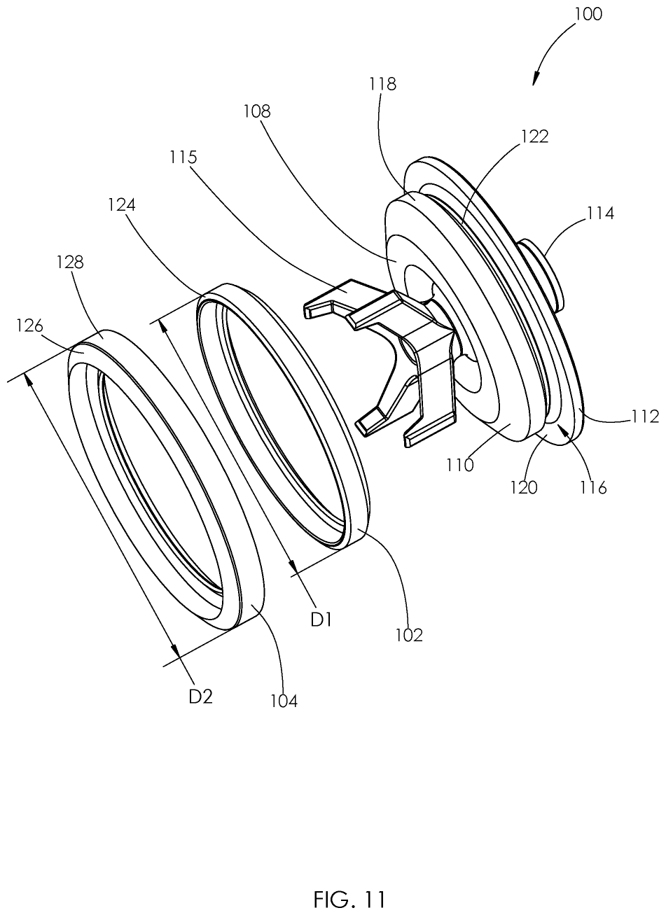

Continuing with FIGS. 8 and 11, a recess 116 is formed in the sealing surface no and the outer rim 112. The recess 116 comprises a first wall 118 joined to a second wall 120 by a groove 122. The first wall 118 intersects the sealing surface no and the second wall 120 intersects the outer rim 112. The first insert 102 is installed within the recess 116 such that it engages the first wall 118 and at least a portion of the groove 122. The second insert 104 is installed within the recess 116 such that it surrounds and engages the first insert 102 and engages the second wall 120 and at least a portion of the groove 122. The first and second inserts 102 and 104 are both annular, as shown in FIG. 11. In alternative embodiments, the inserts may conform to the shape of the valve.

Continuing with FIGS. 8 and 11, the second insert 104 has a different shape from the first insert 102 and takes up a larger volume of the recess 116 than the first insert 102. The first insert 102 has an outer diameter, D1, and the second insert 104 has an outer diameter, D2. The diameter D2 is greater than the diameter D1.

Continuing with FIGS. 7 and 8, the first insert 102 has a first lower surface 124, and the second insert 104 has a second lower surface 126. When the first and second inserts 102 and 104 are installed within the recess 116, the first and second lower surfaces 124 and 126 form an extension of the sealing surface 110. However, at least a portion of the lower surfaces 124 and 126 are positioned on a different plane than the sealing surface 110. That is, the lower surfaces 124 and 126 extend downwards past the sealing surface 110, as shown in FIGS. 7 and 8. The second insert 104 also has an outer surface 128. When the second insert 104 is installed within the recess 116, the outer surface 128 forms an extension of the outer rim 112. However, the outer surface 128 may extend past the outer rim 112.

The second insert 104 may be formed of the same material as the valve insert 66, discussed with reference to FIGS. 3 and 4, and form the same sealing functions as the valve insert 66. The first insert 102 is made of a harder material than the second insert 104. Such material may be made of the same or different compounds as the second insert 104, as long as the first insert 102 is harder than the second insert 104. Such compounds may include, for example, polyurethane, polyethylene, and/or rubber. The second insert 104, for example, may be made of Resilon® polyurethane with a Shore (or durometer) hardness of 90A, and the first insert 102 may be made of a polyether ether ketone (PEEK) with a Shore hardness of 85D. As discussed more below, the first insert 102 is harder than the second insert 104 so that it is more resistant to erosion, helping to extend the life of the second insert 104 and the valve 100.

Turning to FIGS. 12-14, during operation, fluid flows from the lower surface 108 of the valve 100 radially toward the outer rim 112, as shown by the arrows 130 in FIG. 13. Fluid flowing along such fluid path contacts the first insert 102 before contacting the second insert 104. The initial velocity of fluid flowing along the fluid path is relatively high as compared to the velocity once the valve 100 is fully opened, as shown in FIG. 13. In the prior art valve 32, shown in FIGS. 3 and 4, this high velocity erodes a leading edge of the valve insert 66.

In the valve 100, the harder first insert 102 shields the softer second insert 104 from the harmful effects of the high velocity fluid. Thus, a leading edge of the first insert 102 helps deflect high velocity fluid away from the second insert 104. Because high pressure fluid is deflected away from the second insert 104, and because the first insert 102 is more resistant to erosion, the life of the valve inserts 102 and 104 and the valve 100 is extended from that of the valve 32, shown in FIGS. 3 and 4.

The inserts 102 and 104 may be permanently disposed within the recess 116. In alternative embodiments, the inserts 102 and 104 may be releasably installed within the recess 116. In such case, the first and second inserts 102 and 104 may be removed and replaced with a new first or second insert 102 or 104, if needed.

In alternative embodiments, the valve may have different shapes and sizes, as long as it includes a first and second insert, as described above. For example, the valve may be configured so that it is a stem valve, known in the art. In further alternative embodiments, the recess and/or first and second inserts may have different shapes than those shown in the figures, as long as the first insert deflects high pressure fluid away from the second insert. In even further alternative embodiments, the first insert may be installed within a different recess from the second insert, as long as the first insert deflects high pressure fluid away from the second insert.

The various features and alternative details of construction of the apparatuses described herein for the practice of the present technology will readily occur to the skilled artisan in view of the foregoing discussion, and it is to be understood that even though numerous characteristics and advantages of various embodiments of the present technology have been set forth in the foregoing description, together with details of the structure and function of various embodiments of the technology, this detailed description is illustrative only, and changes may be made in detail, especially in matters of structure and arrangements of parts within the principles of the present technology to the full extent indicated by the broad general meaning of the terms in which the appended claims are expressed.

1. An apparatus comprising:
a valve configured to mate with a valve seat; the valve comprising:
a tapered sealing surface;
a recess formed within at least a portion of the sealing surface;
a first insert installed within the recess; and
a second insert installed within the recess and engaging the first insert.

2. The apparatus of claim 1, in which the first insert is made of a first material and the second insert is made of a second material; and in which the first material is different from the second material.

3. The apparatus of claim 1, in which the first insert is made of a first material and the second insert is made of a second material; and in which the first material is harder than the second material.

4. The apparatus of claim 1, in which the first insert has a different shape than that of the second insert.

5. The apparatus of claim 1, in which the first insert and the second insert extend past an outer boundary of the recess.

6. The apparatus of claim 1, in which the first insert has a first lower surface and the second insert has a second lower surface; in which at least a portion of the first and second lower surfaces are positioned on a different plane than the sealing surface.

7. The apparatus of claim 1, in which the recess is the one and only recess formed in the valve body that is configured for receiving an insert.

8. The apparatus of claim 1, in which the second insert occupies a larger volume of the recess than the first insert.

9. The apparatus of claim 1, in which the second insert at least partially surrounds the first insert.

10. The apparatus of claim 1, in which the first and second insert are both annular.

11. The apparatus of claim 1, in which the first insert has an outer diameter, D1, and in which the second insert has an outer diameter, D2; and in which D2 is greater than D1.

12. The apparatus of claim 1, in which a leading edge of the first insert extends below the sealing surface.

13. The apparatus of claim 1, in which the first and second insert form an extension of the sealing surface; in which the sealing surface defines a fluid flow path; and in which fluid flowing along the fluid flow path contacts the first insert before contacting the second insert.

14. A valve assembly, comprising:
the apparatus of claim 1; and
a valve seat having a tapered strike face that corresponds with the sealing surface of the valve.

15. A fluid end, comprising:
a housing having an external surface and an internal chamber;
a conduit formed in the housing and connecting the internal chamber to the external surface;
the valve assembly of claim 14 installed within the conduit.

16. An apparatus comprising:
a valve configured to mate with a valve seat; the valve comprising:
a tapered sealing surface;
a first insert installed within the sealing surface; and
a second insert installed within the sealing surface;
in which the first insert is made of a material that is harder than that from which the second insert is made.

17. The apparatus of claim 16 in which the first insert is in contact with the second insert.

18. The apparatus of claim 16, in which the first and second inserts are both installed within one and only one recess formed in the sealing surface.

19. A valve assembly, comprising:
the apparatus of claim 16; and
a valve seat having a tapered strike face that corresponds with the sealing surface of the valve.

20. A fluid end, comprising:
a housing having an external surface and an internal chamber;
a conduit formed in the housing and connecting the internal chamber to the external surface;
the valve assembly of claim 19 installed within the conduit.
